(19) United States
(12) Patent Application Publication
(10) Pub. No.: US 2012/0295705 A1
(43) Pub. Date: Nov. 22, 2012

(54) GAME DEVICE, GAME CONTROL METHOD, AND NON-TRANSITORY INFORMATION RECORDING MEDIUM THAT RECORDS A PROGRAM

(75) Inventor: Norio HANAWA, Minato-ku (JP)

(73) Assignee: KONAMI DIGITAL ENTERTAINMENT CO., LTD., Tokyo (JP)

(21) Appl. No.: 13/476,162

(22) Filed: May 21, 2012

(30) Foreign Application Priority Data
May 20, 2011 (JP) 2011-114100

(51) Int. Cl. A63F 13/00; A63F 9/24

(52) U.S. Cl. 463/31; 463/43

(57) ABSTRACT

An image of a player photographed by an image capturer and a timing of an operation of a controller by the player is sensed by a sensor, and if the record by an evaluator is a record that exceeds a fixed evaluation, image processing is performed and displayed on a monitor by a display. In addition, if an individual other than the player is photographed, the face of the individual is recognized by a recognizer, and determination is made by the detector as to whether the face is moving, and the player is identified by the determination of the sensor.

### CROSS-REFERENCE TO RELATED APPLICATION

This application claims the benefit of Japanese Patent Application No. 2011-114100, filed on May 20, 2011, the entire disclosure of which is incorporated by reference herein.

### TECHNICAL FIELD

The present invention generally relates to a game device, a game control method and a non-transitory information recording medium capable of computer read-out on which a program is recorded, and more particularly relates to a game device which suitably provides satisfaction to the player by providing a display on a game screen of photographed player images responding to the results of play actions.

### BACKGROUND ART

The evaluation of a player's play results generally occurs in a game device. For example, in published Japanese patent No. 3003851, a game device is disclosed which displays the problems manifest by step positions in the step action timing on a screen; and the sensation of dancing is enjoyed once a play is made in which the player follows the indications of play. The game device detects the stepping action of the player, and scoring is made on the basis of indications relating to the step positions and step action timing; and deviations in the actual step actions taken by the player. By having the player move his body in accordance with displayed subject, dancing can be enjoyed in alignment with the rhythm of the music being played back.

### SUMMARY

With this type of game device, the play results of the player; in other words, the indication of the step position and timing of the step action and the degree to which there is “slippage” in the actual step action of the player, are evaluated. The evaluation results, corresponding to the goodness/badness of the results, are displayed as the number of points or characters on the screen, and the player confirms his own skill at playing by viewing the displayed results.

However, this evaluation display method is commonly used in general game devices, and a still greater satisfactory sense of achievement and sense of unity with the game is sought.

The present invention resolves the aforementioned problems and has the objective of providing a game device, a game control method and a non-transitory information recording medium capable of a computer read-out on which a program is recorded, which suitably provides satisfaction to the player's sense of satisfaction by displaying photographed player images on the game screen responding to the evaluation results of the play actions.

In order to achieve the aforementioned objectives, the game device relating to the first aspect of the present invention is provided with a display, a sensor, an image capturer and an evaluator.

The display displays an indication image showing a type of an action to be taken by a player and a timing on a screen. The indication image showing the types of actions to be taken by the player and the timing thereof is an image showing the types of actions and their timing by the player by layering step position indication marks as they scroll in a fixed direction with standard marks which are fixedly displayed in a specific part of the screen. The standard marks and step position indication marks are marks showing the direction of multiple types of actions, and the standard marks and step position indication marks are arranged so as to layer marks of the same type.

For example, in a music game, the direction of an action to be taken by a player, namely step position indication marks showing lateral and vertical directions, scroll upward from the bottom of the screen. Also, the upper part of the screen is fixedly displayed, and when step position indication marks are overlaid on the standard marks showing the direction corresponding to the step position indication marks, the player uses the controller to accomplish input in the same direction (right) as the direction of action (for example, left) shown by the step position indication marks.

In this instance, the controller, at the time of game execution, indicates the object of player operation, and includes, for example, a mat-type controller, a handheld controller, and a touch panel. On the controller, as the actuator, a key foot switch or the like may also be arranged. On the controller actuator are provided buttons and the like, capable of indicating the direction corresponding to the step position indication marks.

In addition, the player is photographed by a camera, and in a game device which functions as an input device for the player's own actions, indication operations would be accomplished by a hypothetical controller.

The action to be taken by the player are sensed by a sensor.

In a music game, the sensor senses the type of controller actuator pressed by the player and the timing at which the actuator is pressed.

In other words, the player, when the step position indication marks shown on the screen overlap the standard marks, and when the controller actuator, for example, presses an operating button with a foot operated step type controller, input is detected by an internally housed sensor below the operating button.

An image capturer photographs the player. As the photographic means, a CCD (Charge Couple Device Image) camera or the like is used.

A camera comprising the image capturer is attached to the game device. The image capturer photographs images during play by the player as still pictures at fixed intervals.

An evaluator evaluates results based on whether there is conformance between the type of the action and the timing indicated by the indication images and the type of the action and the timing taken by the player and sensed by the sensor.

In other words, the evaluator evaluates the player's results when the player presses an operating button on a controller having the same type of step position indication marks as those displayed on the screen, and determines whether the timing at which the operating button is pressed conforms with the overlapping of the step position indication marks and the standard marks.

If evaluation by the evaluator exceeds a specific level, the display displays the image photographed by the image capturer, along with the indication image, on the screen.

The display, if the results evaluation by the evaluator exceed that specified, by displaying the photographic image of the photographed player and the indication image on the same screen, the image of the photographed player can be displayed along with the progression of the game.

According to the game device of the present invention, since one's own image, photographed by a image capturer, may be displayed on a screen by a display, the player can obtain a sense of satisfaction and a feeling of unity with the game corresponding to the game play results evaluation.

The game device according to the present invention is further provided with a recognizer, a detector and a determinator.

A recognizer recognizes a face of an individual based on the image photographed by the image capturer; a detector detects a movement of the face of the individual recognized by the recognizer; and a determinator determines the individual to be the player when connected to the action of the player sensed by the sensor and to the movement of the face of the individual detected by the detector.

In other words, by mounting a face detecting function on a CCD camera included in a gaming device, if a photograph of the player is taken by the camera, then the location of the face in the image can be recognized. Generally, with this type of game device, for example, with a arcade game device or for a video game device for consumer, in most cases, spectators or someone other than the player are located behind the player. Furthermore, in the case where the player is photographed with a camera on which is mounted a face detection function, the faces of those other than the player are also recognized.

With the game device of the present invention, in the case where the action of the player sensed by a sensor or the movement of the faces of individuals detected by a detector are coupled, the player can be identified.

According to the game device of the present invention, by having a function which may recognize a face in a game device, the player may be easily identified, and information included in the screen of the image of the identified player may be increased.

According to the game device of the present invention, the image photographed by the image capturer is displayed on the screen by the display, after applying an image filter attached corresponding to the evaluation by the evaluator.

According to the game device of the present invention, to the extent that the results evaluated by the evaluator are good, production using the filter shows well, and since the image filter can be selectively applied corresponding to the evaluated results, the degree of player satisfaction can be heightened when there is a high evaluation.

According to the game device of the present invention, the image capturer photographs the image of the player at timing to be taken for the action shown by the indication image displayed on the screen.

In other words, photography is accomplished under conditions in which there is conformance between the time of the photography and the timing indicating the action with the indication image.

According to the game device of the present invention, since the player can be photographed at a timing point of time at which an action is indicated, by having the player himself view the image, one's own skill can be confirmed on the screen, along with which, when there is high evaluation, the superior capabilities of the player can be demonstrated to an audience.

The game control method relating to other aspects of the present invention is a control method executed by a game device provided with a display, a sensor, an image capturer and an evaluator.

In the game control method, displaying an indication image that shows a type of an action to be taken by a player and a timing on a screen; sensing the action taken by the player; capturing the player; and evaluating results based on whether there is conformance between the action and the timing indicated by the indication image and the action and the timing taken by the player and sensed by a sensor, wherein when the evaluation by the evaluation is greater than that specified, the display displays the image photographed by an image capturer on the screen, along with the indication image.

The non-transitory information recording medium capable of a computer read-out on which a program is recorded relating to another aspect of the present invention, creates a composition in which the computer functions as a game device, and executes a game control method in the computer, wherein the game device is provided with a display, a sensor, an image capturer and an evaluator.

Here, a display displays an indication image showing a type of an action to be taken by a player and a timing on a screen; a sensor senses the action taken by the player, an image capturer photographs the player; and an evaluator evaluates results based on whether there is conformance between the type of the action and the timing indicated by the indication image and the type of the action and the timing taken by the player and sensed by the sensor, wherein when the evaluation by the evaluator is greater than that specified, the display displays an image photographed by the image capturer on the screen, along with that of the indication image.

In addition, the program relating to the present invention is capable of recording to a computer read-out capable information storage medium such as a compact disk, flexible disk, hard disk, opto-magneto disk, digital video disc, magnetic tape, semiconductor memory and the like. The program is independent from the computer which executes the program, and is able to handle distribution and sales through a computer communications network. In addition, the information storage medium is independent from the computer and is able to accommodate distribution and sales (information).

According to the present invention, by displaying the image of the photographed player on a game screen corresponding to the results of the player's actions, a game device, game control method and a non-transitory information recording medium capable of computer read-out on which a program is recorded can be provided, suitable to providing a player with a sense of satisfaction.

### BRIEF DESCRIPTION OF THE DRAWINGS

A more complete understanding of this application can be obtained when the following detailed description is considered in conjunction with the following drawings, in which:

FIG. 1 is a schematic diagram showing the summary composition of a typical information processor which realizes the game device relating to an embodiment of the present invention;

FIG. 2 is a perspective diagram showing an external view of the game device relating to an embodiment of the present invention;

FIG. 3 is a schematic diagram showing the summary composition of a mat-type controller connectable to the game device relating to an embodiment of the present invention;

FIG. 4 is a diagram showing an example of the display screen of the game device relating to an embodiment of the present invention;

FIG. 5 is a schematic diagram showing the composition of the subject data of the game device relating to an embodiment of the present invention;

FIG. 6 is a block diagram showing the composition of the game device relating to an embodiment of the present invention;

FIG. 7 is a diagram showing the evaluation section within the threshold time in the game device relating to an embodiment of the present invention;

FIG. 8 is a flowchart showing a game control process executed by the game device relating to the first embodiment of the present invention;

FIG. 9 is a diagram showing an image photographed by a camera in the game device relating to the first embodiment of the present invention;

FIG. 10 is a diagram showing an example of a screen in which photographic images are image processed, built-up in background images and displayed;

FIG. 11 is a diagram showing an image photographed by a camera in a game device relating to a second embodiment of the present invention;

FIG. 12 is a flowchart showing a game control process executed by a game device relating to the second embodiment of the present invention;

FIG. 13 is a flowchart showing a game control process executed by a game device relating to a third embodiment of the present invention;

FIG. 14 is a diagram showing an image photographed by a camera in the game device relating to the third embodiment of the present invention;

FIG. 15 is a diagram showing an image photographed by the camera in a game device relating to the third embodiment of the present invention;

FIG. 16 is a diagram showing the relationship between the action of a player and the face movement in the third embodiment of the present invention;

FIG. 17A is a graph showing the relationship between the amount of vertical movement of the player face and the elapsed time in the third embodiment of to the present invention;

FIG. 17B is a graph showing the relationship between a signal sensed by a sensor and the elapsed time in the third embodiment of the present invention;

FIG. 17C is a graph showing the correlation between the vertical movement of the player face and a signal sensed by a sensor in the third embodiment of the present invention;

FIG. 18 is a diagram showing an external view in the case of playing with two players in a fourth embodiment of the present invention;

FIG. 19 is a diagram showing a screen for specifying the image of two players in the fourth embodiment of the present invention;

FIG. 20 is a diagram showing a game screen in the case of playing with two players in the fourth embodiment of the present invention; and

FIG. 21 is a diagram showing an example of a screen in which a photographic image of the player is layered in background images and displayed.

### DETAILED DESCRIPTION

Embodiments of the present invention are explained hereafter. In order to facilitate ease of understanding, an explanation is provided of an embodiment which realizes the present invention, by using an information processor used for games. However, the following explained embodiment is provided for explanatory purposes, and does not limit the scope of the invention of the present application. Furthermore, it is possible for one skilled in the art to adopt an embodiment with equivalent substitutions for each or all of the essential elements, and these embodiments also are included in the scope of the present application.

### First Embodiment 1

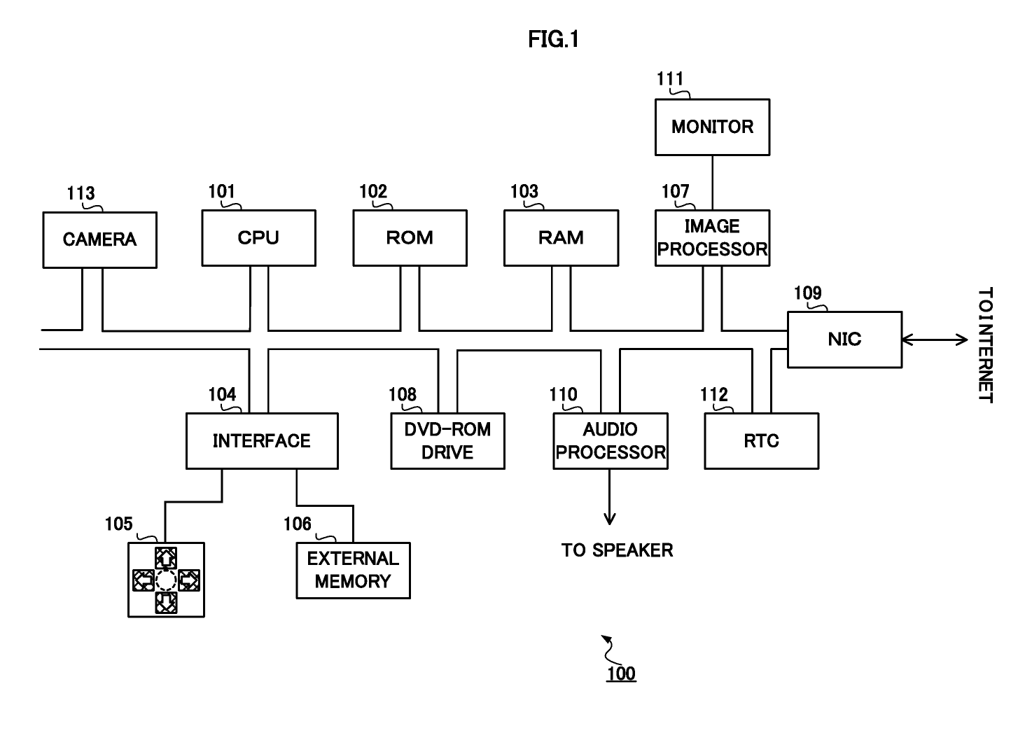

FIG. 1 is a schematic diagram showing the summary composition of a representative information processor which satisfies the function of the game device relating to an embodiment of the present invention, by executing a program.

An information processor 100 is provided with a CPU (Central Processing Unit) 101, a ROM (Read Only Memory) 102, a RAM (Random Access Memory) 103, an interface 104, a mat-type controller 105, an external memory 106, an image processor 107, a DVD-ROM (Digital Versatile Disc ROM) drive 108, an NIC (Network Interface Card) 109, an audio processor 110, a monitor 111, an RTC (Real Time Clock) 112 and a camera 113.

The CPU 101 controls all of the operation of the information processor 100, and handles exchanges between each compositional element and connected control signals or data. In addition, the CPU 101 is able to accomplish arithmetic operations of addition, subtraction, multiplication and division, logical sum, logical product, logical NOT determination operation, and bit operations of bit sum, bit product, bit inversion, bit shift and bit rotation and the like using an ALU (Arithmetic Logic Unit) (not shown in the diagram) relative to a high-speed accessible storage region known as the register (not shown in the diagram). Furthermore, high-speed saturation operations of addition, subtraction, multiplication and division and the like, trigonometric functions and the like, and vector operations for multimedia process correspondence can be handled by the CPU 101 itself, or realized with an included co-processor. Mounting a DVD-ROM to the DVD-ROM drive 108, the game device of the present embodiment can be realized by inserting the power source of the information processor 100.

In the ROM 102 is stored an IPL (Initial Program Loader) executed immediately after power source insertion, by which execution the program stored in the DVD-ROM is read-out to the RAM 103, and execution commences by the CPU 101. In addition, in the ROM 102 is stored an operating system program or each type of data essential to the operational control of the information processor 100.

The RAM 103 stores data and programs. The RAM 103 retains the program and the data read from the DVD-ROM and other data necessary for advancing a game and chat communications. The CPU 101 has a variable area provided in the RAM 103. The CPU 101 may perform a calculation by causing the ALU directly to operate on a value stored in the variable area. The CPU 101 may once store a value stored in the RAM 103 in the register, and may perform a calculation on the register to write back calculation results in the memory.

The mat-type controller 105 connected through the interface 104 receives operational input accomplished at the time a player executes the game.

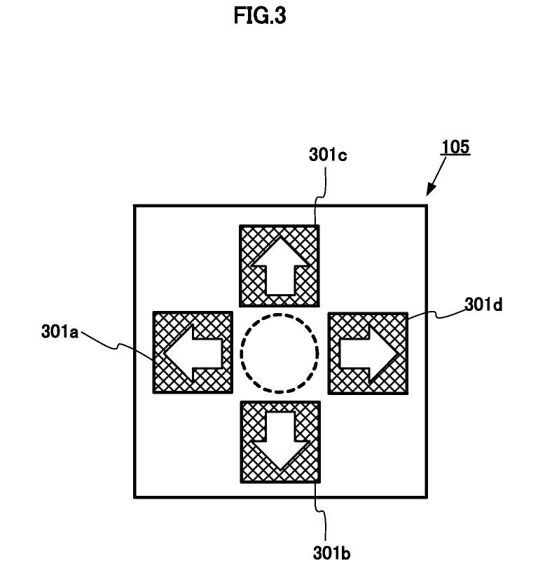

FIG. 3 is an overhead view of a summary diagram of the mat-type controller 105 arranged on a floor. In a specific region of the mat controller-type 105 an input indicating “left” arranges a button 301a received from the player; an input indicating “rear” arranges a button 301b received from the player; an input indicating “front” arranges a button 301c received from the player and an input of “right” arranges a button 301d received from the player, respectively. In addition, in FIG. 3, the position shown by the circle of the dotted lines is the home position HP of the player.

In the following explanation, a state in which buttons 301a-301d are pressed by the player is referred to as a “pressed state”, and a state in which they are not pressed is referred to as a “non-pressed state”. Regarding buttons 301a-301d, the CPU 101 determines whether it is in a pressed state or in a non-pressed state.

In the present embodiment, the mat controller-type 105 is not limited to a state arranged on the floor, but may also be a state held by the hand.

The external memory 106 which is detachably connected through the interface 104 contains data which shows a condition of a player of games and the like (past results and the like); data showing a state of progression of the game, and in the case of network competition, data of a chart communications log (record) and the like, which are stored in a manner which can be re-written. The player, by performing indicated input through a mat-type controller 105 is able to store the data in suitable for the external memory 106.

After the image processor 107 processes data read out from DVD-ROM by an image computer processor (not shown in the diagram) which includes the CPU 101 or the image processor 107, the data is stored in a frame memory (not shown in the diagram) which includes image processor 107. Image information stored in the frame memory is converted to video signals at specific synchronized timing and output to the monitor 111 connected to the image processor 107, making it possible to display each type of image.

In order to realize a game, image data or audio data attached to programs and a game are stored in a DVD-ROM mounted in the DVD-ROM drive 108. By the control of the CPU 101, the DVD-ROM drive 108 performs read-out processing relative to the mounted DVD-ROM, and, reads out essential programs or data, and temporarily stores it in the RAM 103 and the like.

In addition, the image computer processor is capable of high-speed permeation calculations of two-dimensional image layer alignment calculations or a blending or the like, and each type of saturation calculation.

In addition, where virtual spacing is composed in three-dimensions, arranged in three-dimensional spacing, polygon information where information relating to each type of attached texture is rendered by means of the Z buffer method, and where polygons arranged in virtual space from a specific line of sight position can also be executed, can be calculated at high-speed to obtain rendered images with an overview from a specific line of sight.

Furthermore, by cooperative action between the CPU 101 and the image computer processor, a character string may be drawn in the frame memory as a two-dimensional image, or drawn on each polygon surface, by following the font information which defines the shape of the characters.

The NIC 109 connects the information processor 100 to a computer communications network (not shown in the diagram) of the INTERNET or the like, and follows a 10 BASE-T/100 BASE-T standard when composing a LAN (Local Area Network), and is composed of: an analog modem for connecting to the INTERNET using a telephone circuit; an ISDN (Integrated Services Digital Network) modem, an ADSL (Asymmetric Digital Subscriber Line) modem; a cable modem or the like for connecting to the INTERNET using a cable television line and an interface (not shown in the diagram) used as a mediator between these and a CPU 101.

The audio processor 110 converts audio data read out from the DVD-ROM to an analog audio signal, and outputs the audio from a connected speaker (not shown in the diagram). In addition, the audio processor 110 generates sound effects or musical data to be generated during the progress of the game under the control of the CPU 101, and outputs the corresponding audio from the speaker.

If the audio data stored in the DVD-ROM is MIDI (Musical Instrument Digital Interface) data, the audio processor 110, while referring to provided sound source data, converts the MIDI data to PCM (Pulse Code Modulation) data. In addition, in the case of ADPCM (Adaptive Differential Pulse Code Modulation) format or the Ogg Vorbis format or the like compression completed audio data, the data is developed and converted to PCM data. The PCM data performs D/A (digital/analog) conversion at timing corresponding to its sampling frequency, making audio output possible by outputting it through a speaker.

The monitor 111 is connected to the image processor 107, and image information is displayed by cooperative action between the CPU 101 and an image computer processor. The monitor 111 is composed from an LCD (liquid crystal display), and an organic EL display (organic Electro-Luminescence display) and the like. Utilization is made of a general placement type or HMD (Head Mounted Display) type.

The RTC 112 is a device for time use which includes a crystal oscillation element or a development circuit or the like. The RTC 112 supplies electric power from internally stored batteries, and continues to operate even when the electric power source of the information processor 100 is off.

The camera 113 photographs the situation of a player's play as a still picture for each fixed interval.

Other than this, the information processor 100, using a large capacity external storage device of a hard disk and the like, may also be composed so as to achieve the same function as the ROM 102, the RAM 103, the external memory 106, and a DVD-ROM and the like mounted to the DVD-ROM drive 108.

The information processor 100 explained above corresponds to a so-called “game device for consumers”. However, the present invention can be realized if image processing is performed so as to display virtual space. Furthermore, the present invention can be realized using various calculators such as portable telephones, portable game devices, karaoke devices, and general business computers.

For example, general computers, in the same manner as aforementioned information processor 100, equipped with a CPU, a ROM, a DVD-ROM drive and an NIC, are equipped with an image processor provided with simpler functions than the information processor 100. The external storage device, other than possessing a hard disk, is capable of using a flexible disk, an opto-magneto disk, or magnetic tape or the like. In addition, rather than a mat-type controller 105, use is made of such input devices as a keyboard or a mouse or the like.

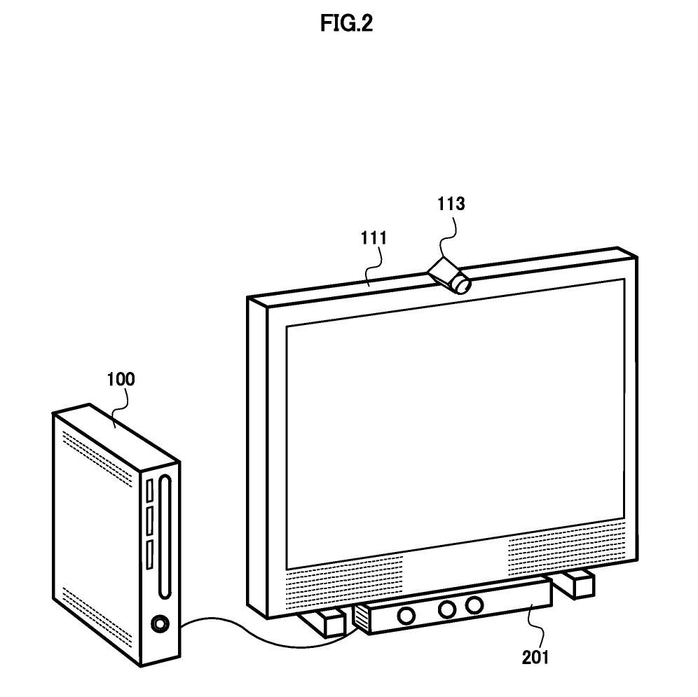

FIG. 2 is an external diagram showing a state in which the monitor 111 is connected to the information processor 100. To the monitor 111 is connected the CCD camera 113.

The CPU 101 analyzes the image data which manifests images photographed by the camera 113, and distinguishes a player body part (for example, the player's hand, foot, or face or the like) included in the image. In the techniques of image analysis, for example, techniques include an analysis by means of pattern recognition, an analysis by extracting the characteristic points and an analysis by calculation of spatial frequency. Photography is continuously performed by the camera 113 at fixed intervals during playing the game.

In addition, an input device 201 is connected to the monitor 111, and may be arranged in the vicinity of the monitor 111, on which the game is displayed. The input device 201 is an input device used in lieu of a mat-type controller, and is provided with a camera which photographs players and the like.

The input device 201 is provided with a depth sensor which measures the distance to the player (player's optional member) from the input device 201. For example, the input device 201 radiates infrared rays in the periphery, and detects the reflected waves of the infrared rays. Also, the input device 201 seeks the distance (also referred to as “depth” hereafter) to a body which reflects the radiating waves from the discharge opening of the radiating waves based on the difference of phase between the radiating waves and the reflected waves, or the duration for radiating infrared ray detected as reflected waves (flying time). Detection of the depth by the depth sensor is repeatedly accomplished at fixed time intervals, concerning the respective directions in which the ultraviolet rays may be discharged.

By including a depth sensor, the information processor 100 is capable of a more detailed comprehension of the 3-dimensional shape position or a shape of an object arranged in real space. More specifically, the CPU 100, as a result of an image analysis of 1st image data acquired in the 1st time period and 2nd image data acquired in the 2nd time period, determines if an included part shows the head of the player in both the 1st image data and the 2nd image data. The CPU 101 is able to determine the extent of movement and the vertical or lateral movement of the head of the player viewed from the camera, from changes in the position of the head within the 1st image data, or changes in the position of the head within the 2nd image data. Further, determination is also possible of the extent of movement (the extent of moving closer to the camera or moving away from the camera) and in which direction the player's head is pointing viewed by the camera, from changes in the degree of depth of the head in the 1st image data and the degree of depth of the head in the 2nd image data.

In this manner, the CPU 101 is able to understand digitalized 3-dimensional movements of the player in real space in so-called “motion capture” based on images photographed by the camera which includes the input device 201 and the distance (depth) measured by a depth sensor which includes the input device 201.

For example, in a dance game, if a player performs appropriate dancing motions corresponding to indication images in the front of the monitor 111 screen (in other words, in front of the input device 201), the CPU 101 recognizes motions which correspond to the player's dancing. Also, the CPU 101 is able to accomplish game progression corresponding to the recognized motions. In other words, the player is able to input specific indications by freely moving his own body, without the use of a touchpad-type controller or the like. The input device 201 assumes the role of the so-called “controller” by receiving the indicated input from the player.

### Explanation of a Display Screen

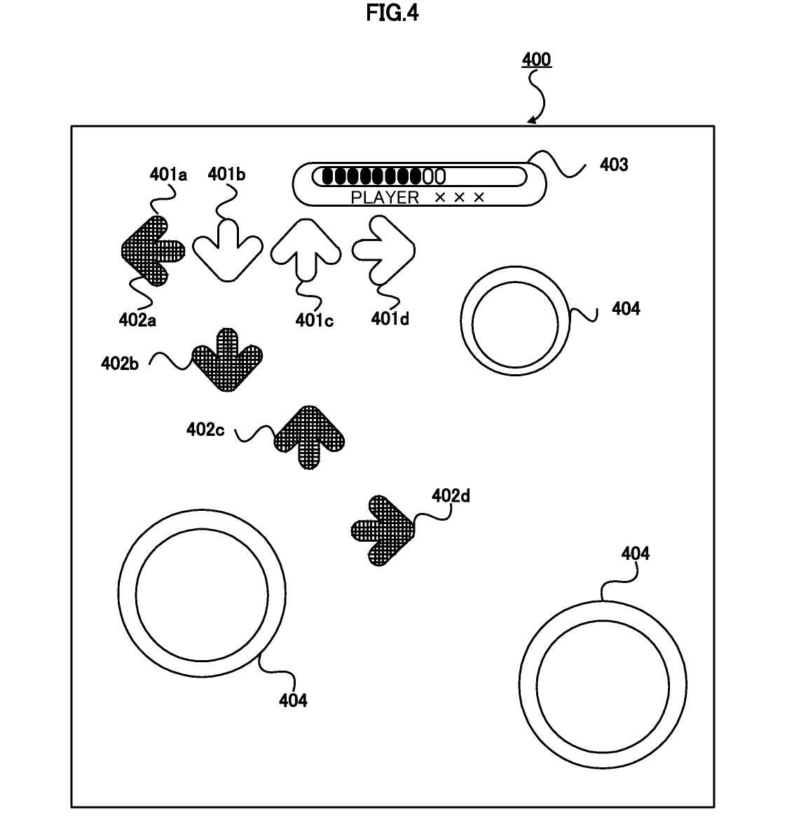

An explanation concerning a display screen of the game device relating to the present embodiment is provided herewith, with reference to FIG. 4. Moreover, the game device relating to the present embodiment is explained as a game device which executes a dance game.

The game device displays various information essential to a dance game. For example, the game device, prior to commencing the game, displays a list of tunes, and prompts a player to select a desired tune. The game commences upon selection of a tune by the player.

FIG. 4 is an example of the display screen of the game device relating to the present embodiment. Standard marks 401a, 401b, 401c, 401d (hereafter generalized as standard 401 marks, as needed) displayed by a game screen 400 are fixed images showing the timing of the step action of the player. Step position indication marks 402a, 402b, 402c, 402d (hereafter generalized and referred to as step position 402 marks) are scroll displayed facing upward from the bottom of the screen. The scroll displayed step position indication 402 marks, at a timing which builds up with the standard 401 marks, when the player performs the step position actions, the obtained points are added, and the values shown on the gauge (a dance meter 403) are updated.

The dance meter 403, in the present embodiment, is displayed on the upper part of the screen 400. In addition, a background image 404 is displayed in the background, in coordination with the game music and game content.

In the game screen 400 of FIG. 4, the step position indication 402 marks move upward from the bottom of the screen 400. However, the movement direction of the step position 402 marks is not limited to this, and the direction may be optionally determined. For example, the step position indication 402 marks may also move downward from the upward direction of screen 400. In addition, the step position indication 402 marks may move horizontally across screen 400 (from the right side to the left side of the screen 400, or from the right side to the left side of screen 400) or the like. Moreover, the state of the step position indication 402 marks is merely an example, and another state may be used.

### Composition of Subject Data

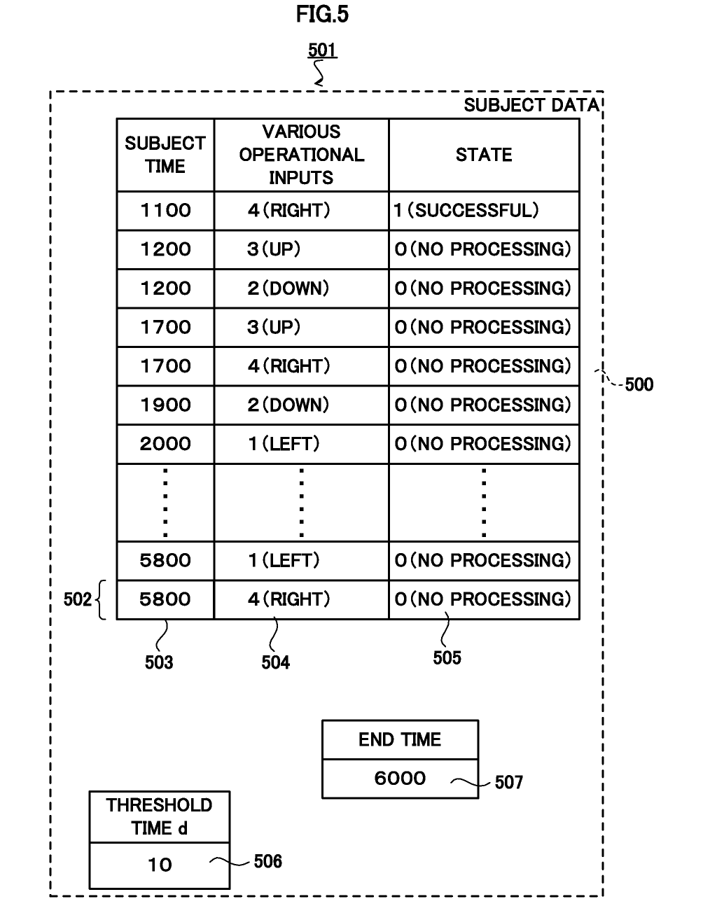

In the present embodiment, as the data for realizing the game control process, a tune data series and subject data are prepared. The subject data includes multiple subject times, and various input operations corresponding to the respective multiple subject times and threshold times. FIG. 5 shows a schematic diagram of the subject data.

The subject data 500 corresponds to scores in the music category. In the present embodiment, the subject data 500 includes a table 501 formed from multiple records 502, threshold time 506 (value=d), and end time 507. Each record 502 has a region in which is stored the subject time 503, various operational inputs 504 and a state 505. Each record 502 corresponds to a note.

The subject time 503 is the time from the start of a game to where the corresponding step indication 402 marks reach the standard 401 marks. In the present embodiment, the subject time 503 is shown by the integer value becoming the unit of the vertical synchronization interruption cycle. Moreover, the subject time 503 is information read-out from a DVD-ROM.

The various operation input 504 is data which, after the passage of the subject time from game's commencement, shows which button from among buttons 301a, 301b, 301c and 301d of the mat-type controller 105 has been stepped on by the player. The various operation input 504 is information read out from a DVD-ROM. In the various operation input 504 are stored the numbers “1”-“4” representing the operations to be performed. For example, a button 301a shows “1”, a button 301b shows “2”, a button 301c shows “3” and a button 301d shows “4”, respectively. However, the values showing the type of button are not limited to these, but other corresponding values can be optionally attached.

A state 505 shows the condition of operational input in each record 502. Immediately following the commencement of the game, a state 505 is initialized to “0” showing “no processing”, and concerning subsequent processing, “1” shows “successful”, and “2” and the like shows “error”. However, the value showing the state is not limited to these, but other corresponding values can be optionally attached.

The threshold time 506 represents the permissible range of the value of the operational input time by the player and the subject time 503. If the time difference between the timing of the required operational input and subject time 503 is less than the threshold time, and if there is conformance between the various operational input 504 and the various pressed buttons 301, then the operational input is perceived as having been successful.

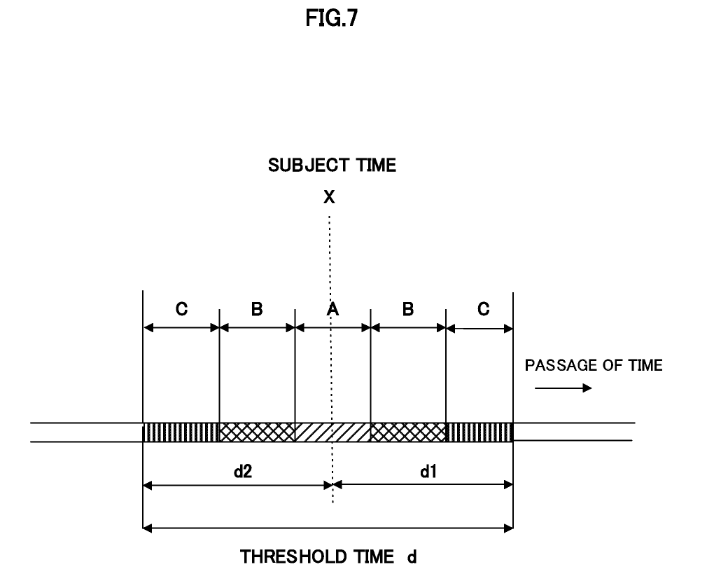

The threshold value d makes subject time 503 to be a boundary, composed from the front half d 1 and the rear half d 2 as shown in FIG. 7.

In addition, the threshold time 506 is represented by an integer value in which the vertically synchronized interruption cycle is made to be the unit.

The end time 507, shows the time from the beginning of the game to the end of playing back a musical composition. Furthermore, the end time 507 is manifest by a numerical value by which the vertical synchronization allocation cycle is made a unit.

### Composition of Game Device

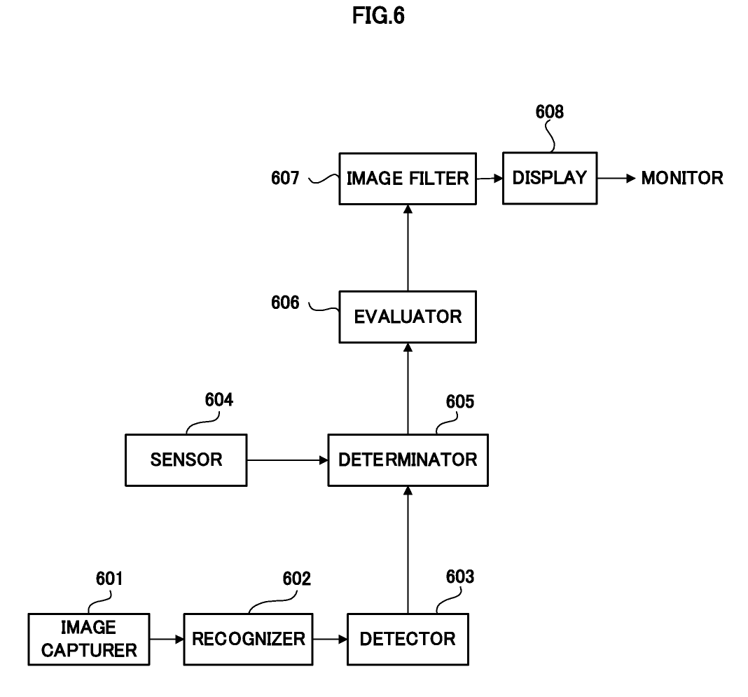

Next, an explanation is provided concerning the composition of each part of the game device of the present embodiment, with reference to FIG. 6.

The information processor 100 relating to the present embodiment includes an image capturer 601, a sensor 604, an evaluator 606 and a display 608.

The image capturer 601 uses afore-described the CCD camera 113 or the like, and photographs the play images of the player. The CCD camera 113 photographs the circumstances of play by the player as still images taken at fixed intervals, and the photographed images are stored in the RAM or the like. The photography is desirably timed to take actions showing indication images.

In addition, at the time of using the input device 201, the same effect can be achieved by using a camera internally stored within the input device 201.

The sensor 604 senses whether there has been an action by the player, and detection is realized by a sensor internally stored within the mat-type controller 105.

If a press operation has been performed by the player, then the sensor 604 senses the timing at which various of the press operated buttons 301a-301d have been pressed.

In other words, the sensor 604, at the same time as sensing whether the timing includes the depression of mat-type controller 105 within a time after the threshold time (d 2) 506 has passed from the subject time 503, from the preceding time of only the threshold time (d 1) 506 from the subject time 503, detects whether the same controller has been depressed as the one depressed for the indicated action.

The evaluator 606, based on the detection results of the sensor 604, evaluates, for example, whether a press operation has occurred within the threshold time, and if it has, determines it to be “good”, and if the press operation is outside of the threshold time, evaluates it as being “bad”.

For example, within the threshold time, various required operational input is “4” which shows a right lateral button. Within the threshold d, if the right direction button 301d is depressed, then the operational input is judged to have succeeded, and the state record becomes 1.

In addition, within threshold time d corresponding to subject time 1200, various required operational input 404 is “3”, which shows a upper direction button. Within the threshold time d, if the vertical button 301c is depressed, the operational input is determined to have succeeded, and the state record becomes 1.

As shown in FIG. 7, threshold time d and its relationship to the subject time can be divided into three regions. Within the threshold time d, where the subject time is X, the specific range before and after X is differentiated as A, the next specific range outside of this is differentiated as B and the furthermost outside range is differentiated as C.

The results are determined by whether the timing of the detected player action is included and within which range among aforementioned A, B or C, and image processing is performed corresponding to the determination results. In other words, the results are determined by whether and to which aforementioned division the detected player's action timing corresponds, and as indicated hereafter, a image filter is appropriately selected corresponding to the determined results, enabling changes to be made to the displayed image corresponding to the results.

The display 608, on the monitor 111, outputs a signal which displays the step position indication 402 marks corresponding to the period from the preceding time of only the 1st time from the subject time 503 to the elapse of only the 2nd time from the subject time 503 on the screen. In addition, display 608 displays the background image for each type of message or the like on the screen.

Moreover, in the present invention, the display 608 should at least, in the subject time 503, display the corresponding step position indication 402 marks on the screen.

The display 608, if the results evaluated by the evaluator 606 exceed a fixed value, for example, if the input operation is performed by the player corresponding to section A and section B within the threshold time d, the results are determined to be good, and the photographic image of the player is displayed as an overlay on the background image of the screen.

### Game Processing Flow

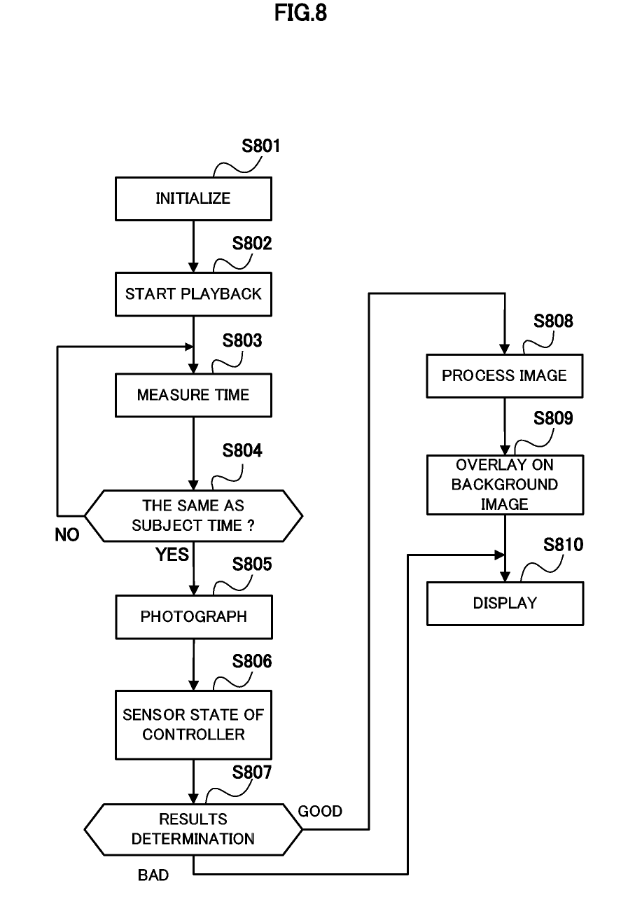

Next, an explanation is given concerning the operations of the game device relating to the present embodiment, with reference to FIG. 8. FIG. 8 is a flow chart showing game control processing executed by the information processor 100 relating to the present embodiment.

The CPU 101 reads out and initializes (Step S801) subject data 500, music data, and image data in a specified data region of the RAM 103 from a DVD-ROM.

Also, the CPU 101 starts the game playback, and the player plays (step S802) the game following the indication images displayed on a game screen. Once game replay has commenced, as shown in FIG. 4, the game is displayed with standard marks 401 fixedly displayed on the game screen 400, step position indication marks 402 which scroll upward from the bottom of the screen, background images 404 and a dance meter 403 as the game images.

In addition, upon the commencement of game playback, the CPU 101 commences (step S803) time measurement. Also, the measured time determines (step S804) whether there is conformance with the subject time 503 determined by the subject data 500.

If the measured time is the same as the subject time (step S804; YES), the player is photographed (step S805) by the camera 113 comprising the image capturer 601. If the measured time is the same as the subject time (step S804; NO), then time measurement continues without photographing the player with the camera 113.

The timing of photography, in the present embodiment, is synchronized with the subject time, and is timing in which a photograph is taken at the same time as the subject time. The timing of the photography is not limited to this time, but may also take place at fixed time intervals. In other words, it is also possible for photography to take place continuously at fixed time intervals from the commencement of the game.

Also, the sensor 604 senses the state of the controller (Step S806). In other words, when the step position indication marks 402 are overlaid by the standard marks 401, the sensor 604 senses whether the player has pressed a controller button corresponding to the same type of mark as that shown by the indication image.

If the results determined (step S807) by the evaluator 606 based on the results sensed by the sensor 604 exceed a fixed level, the results are determined to be “good” (step S807; good), and the process moves (step S808) to image processing. If the results do not exceed the fixed level, the results are determined to be “bad” (step S807; bad), and the photographic image of the player is not displayed. As shown in FIG. 4, only images of the standard marks 410, the step position indication marks 402, the background image 404 and the dance meter 403 are displayed (step S810).

Here, concerning the goodness/badness of the results, various determination standards may be adopted. In other words, adoption can be made of various determination standards or the like, such as, within the threshold time d, a determination standard by which the results of the time of performing the controller input operation are made to be “good”, and by which the results of times of other than the threshold time d are made to be “bad”; and within the range of the threshold time d of “A” and “B”, the time of performing the controller input operation is made to be “good”, and other times are made to be “bad”; and where the time of performing the controller input operation only within the range “A” of the threshold time d is made to be “good”, and other times are made to be “bad”.

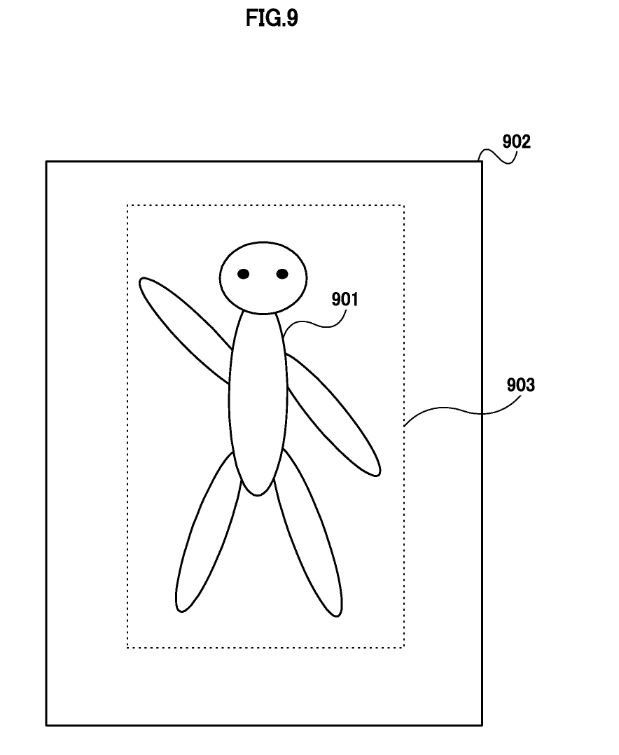

Moving to image processing (step S808), image processing is performed in order to make the photographed player image appropriately large when pasting it on the game screen. In other words, in the photographed image 902 of FIG. 9, the region enclosing the photographed part of player 901 is cut out using technology such as trimming and the like for the display image 903.

As an image processing technique, processing and the like is accomplished using a trimming process or the like which cuts out only a part of the image, or a process which uses an image filter 607.

Among image filters 607 are included a filter for brightening the image, a filter for making the image black and white, a filter for increasing or decreasing the resolution degree, a filter for emphasizing the edge and a filter which uses solarization. In this instance solarization refers to a technique for inverting the black-and-white of a monochrome photograph at the time of developing, by selective overexposure.

The photographic image of the player executed by the image processor, in game screen 400, is overlaid (step S810) as a display image 903 on the background image 404. More specifically, the image of the game screen 400 is chronologically built up from the background image 404, a display image 903 and indication images 401 and 402. Upon completion of the overlay processing of all of the images, the images are displayed on the screen in an overlaid state (step S810).

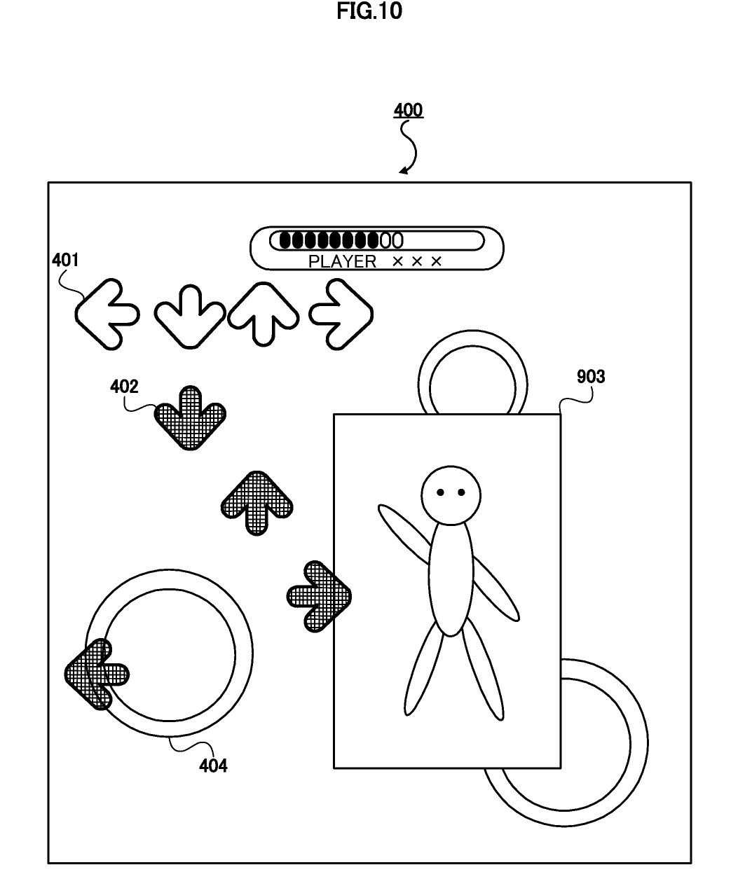

In FIG. 10 the photographic image executed by image processing is overlaid as a display image on a background image, and shown as a sample display on a monitor. The image is displayed as the chronological overlay of the background image 404, the display image 903 and the indication images 401 and 402.

When the player's results exceed a fixed level of evaluation, his own photographic image can be seen as a background overlay image on the game screen.

Moreover, in the present embodiment, the displayed image is an image photographed at the same time as the subject time. However, in a fixed time, from the game commencement time to the time of photography, immediately prior to being displayed on the display screen, the photographed image is used as a display image.

In the present embodiment, evaluation by the evaluator 606 is represented with the 2 evaluations of “good” or “bad”, and only when evaluated as “good”, is the photographed image of the player displayed as a display image. As indicated above, since the threshold time d is divided into the several steps of A, B and C, evaluation is possible corresponding to the steps.\

Furthermore, the evaluation “good” can be divided into multiple steps, and the display method of the photographed image of the player can be changed corresponding to the evaluation steps. The action timing of the player, depending upon which of the divisions A, B and C it belongs to among the threshold time d divisions, is evaluated, for example, as A=(Marvelous), B=(Excellent) and C=(Good).

Also, different image processing can be performed corresponding to the results of A, B and C. Processing techniques are possible using trimming or an image filter in image processing.

For example, by using an image filter, to the extent that the results are good, the image resolution can be increased, and the emphasis on the edges can be strengthened. In addition, white/black contrast is strengthened by solarization and the like, and to the extent that the results are good the production shows well. By such a process, a discriminating display is possible corresponding to the results.

### Second Embodiment

Next, an explanation is provided concerning another embodiment of the present invention. In aforementioned First Embodiment, an explanation is provided concerning an information processor which has an input device which uses a mat-type controller.

In the present embodiment, an explanation is provided of an information processor which digitalizes and inputs three-dimensional movements of the player in real space based on images photographed by a camera provided with aforementioned input device 201, and the distance (degree of depth) measured by a depth sensor provided with the input device 201.

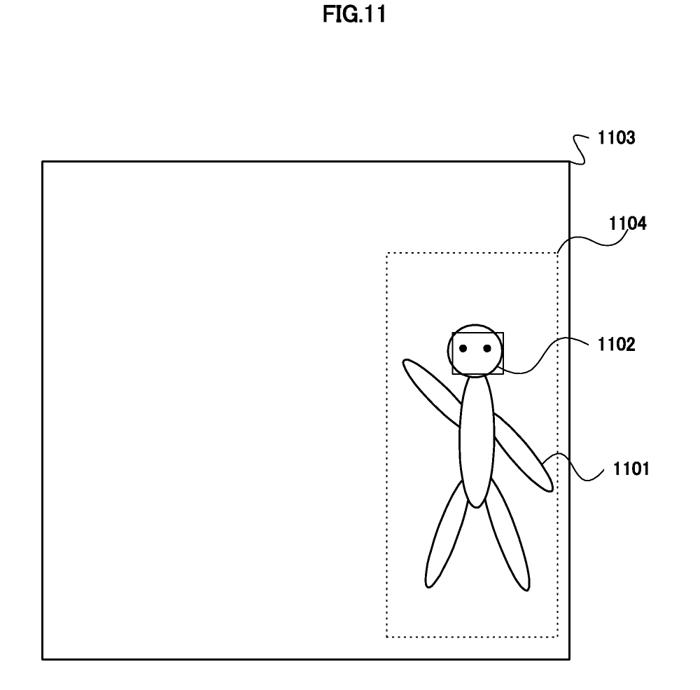

In the present embodiment, there is no need for the player to play in a location in which a mat-type controller has been laid down, such as is shown in embodiment 1. Furthermore, as shown in FIG. 11, depending upon the play position of the player, a player 1101 may also be photographed in a corner of the screen. In such a case, the position of the player is confirmed, and it is necessary for only the part showing the photographed player to be cut out and image processed.

Therefore, in the present embodiment, as shown in FIG. 6, a recognizer 602 is further provided.

The recognizer 602 recognizes individual faces based on images photographed by a camera. In order to recognize human faces, a face detection technology which is commonly used is adopted. As the face detection technology, comparison is made between photographic images and an accumulation of multiple samples of the face, extracted from characteristic points of the parts of the face, including the eyes, nose and mouth and the like, used for facial recognition, and by detecting, for example, the color of the flesh of the face.

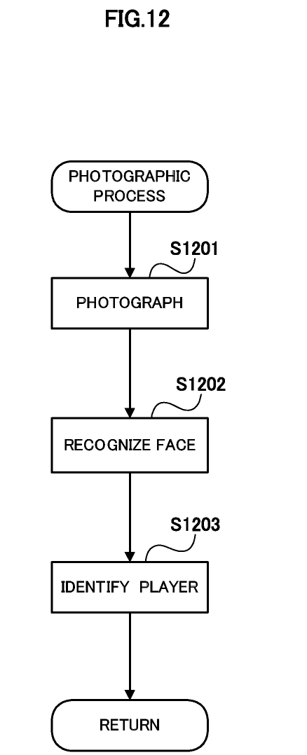

The information processor 100 in the present embodiment performs the same processing as the flowchart shown in FIG. 8. However, the parts of the photographic process (step S805) differ. The photography part of the present embodiment form is explained hereafter with reference to FIG. 12.

Upon photographing the player image (step S1201), the location of the player's face is recognized by the recognizer 602. In other words, using face detection technology by the recognizer 602, parts 1102 of the face are recognized (step S1202) as shown in FIG. 11, and by recognizing the facial parts 1102 of the player, the location of the player in the photographic image 1103 can be identified (step S1203). Moreover, the photographed image is preserved in the RAM 103 and the like.

Subsequently, the condition of the controller, in other words, the type of operation and its timing, is determined (step S806), and the results evaluated, and if the results exceed a fixed value, the process moves (step S808) to the image processing step.

In the image processing step (step S808), since the face of the player is detected by the recognizer 602, and the position of the player identified, the process cuts out only the part of the player from the photographic image; and specifically, in FIG. 11, the region shown by the dotted line 1104 is cut out as a display image. The display image 1104, after being cut out, in the same manner as shown in FIG. 8, chronologically layers (step S809) the background image 404, the display image 1104 and the indication images 401 and 402. Upon completion of layer processing of all of the images, the contents are displayed on a screen (step S810).

### Third Embodiment

In aforementioned First and Second Embodiments, the photographed object was only one player. However, in actuality, there are few instances in which only one player plays a game. When playing with a game device for a consumer, surrounding the player members of the family or friends or the like will be present as game participants or spectators. In addition, when a player plays an arcade game device, friends or unidentified spectators gather together around the player in a game center.

Under these circumstances, individual subjects other than the player are photographed, and without determining the identity of the player, an official player sometimes cannot be displayed on a screen. Such circumstances are appropriate in the present embodiment, and hereafter, a specific explanation will be provided of a case in which multiple individuals are photographed.

The present embodiment, as shown in FIG. 6, is further provided with a detector 603 and a determinator 605.

The detector 603 detects which individual is moving among the individual subjects whose faces have been detected. Since, when photographs are taken at fixed intervals the images are preserved, the movements of individual subjects can be tracked with the passage of time.

Specifically, as a result of image analysis of the CPU 101's acquisition of the 1st image data acquired in the first time period, and the second image data acquired in the second time period, and the included display components of the face of both players of the first image data and the second image data are determined. The CPU 101 is able to determine the extent to which the face of the player has moved and in which direction, vertically or horizontally, as viewed from the camera, from changes in the position of the face within the first image data and the position of the face in the second image data.

Moreover, in addition to photographs taken by the camera, if a depth sensor is used, movement toward the front or rear direction can also be detected.

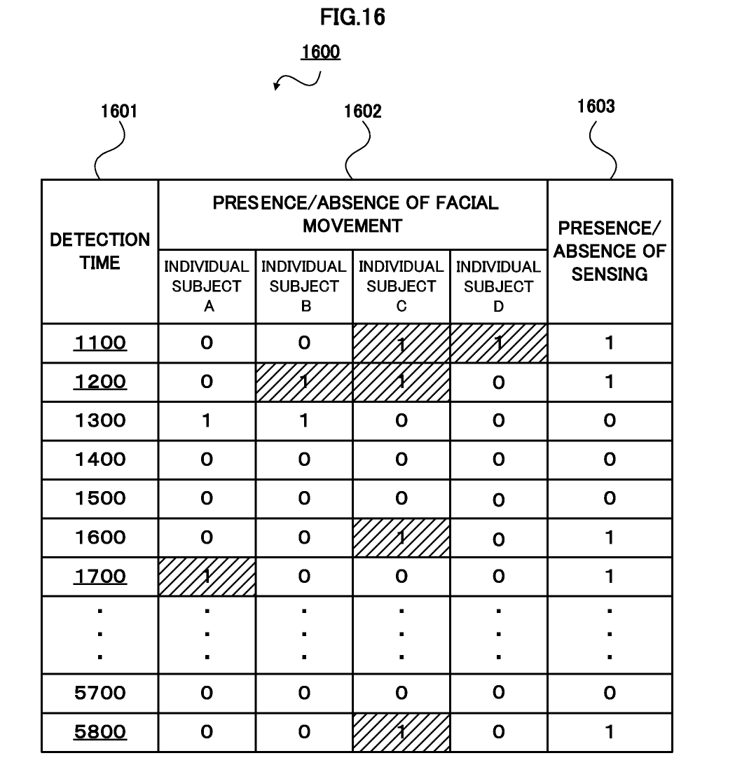

FIG. 16 is a table showing for determining the player from the movement of the faces of individual subjects detected by the detector 603 and the sensing results of the sensor 604.

Determination data 1600 is composed from the detection time 1601, the presence/absence of facial movement 1602 and data 1603 showing the presence/absence of detection.

The detection time 1601 is a time for determining whether there has been movement and vertical movement in particular, of the face, by means of the sensor 604, and is a time which intermittently shows the elapsed time from the commencement of the game. The detection time 1601 is shown by an integer value in which the vertical synchronization interruption cycle is made to be the unit. Moreover, the detection time 1601 is information read out from a DVD-ROM. In addition, in the detection time 1601, the time the bottom line is the subject time 503.

Column relating to the presence/absence of facial movement 1602 applies an optional recognition signal relative to individual subjects whose faces are recognized, and for each recognition signal applied to an individual subject, the presence/absence of (vertical) facial movement is entered. In the present embodiment, recognition signals A, B, C and D are assigned relative to the individual subjects whose faces have been recognized. The recognition signal can apply an optional signal in order to differentiate each individual with an alphabetical or numerical character or the like.

If facial movement has been determined to have occurred by the detector 603, then “1” is entered in column relating to the presence/absence of the facial movement 1602 of each individual subject; and “0” is entered if it is determined that no movement has occurred.

During the detection period, in the case that the sensor 604 determines that the controller has been pressed, the sensor enters “1” in the detection presence/absence column 1603, and if it is determined not to have been pressed, the sensor 604 enters “0”.

The determinator 605 determines whether the actions of the player detected (presence/absence detected) by the sensor 604 are coupled to the movement of the face (presence/absence of facial movement) of an individual detected by the detector 603.

In other words, in a specific detection time, with an individual for whom it has been determined by the detector 603 that the face is moving, since where there is no sensing by the sensor 604 that the controller has been pressed it is determined that the actions of the player are not coupled, that individual subject is not determined to be an official player. By this series of processes, an official player can be identified from among multiple individual subjects in photographic images.

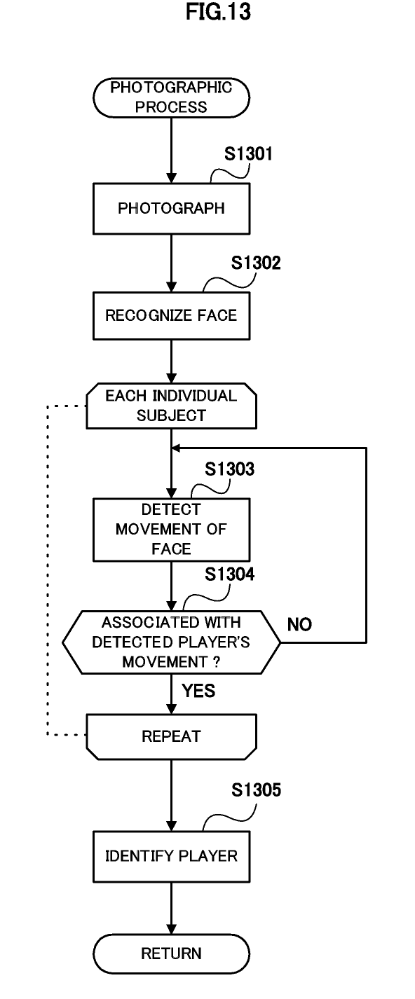

In the present embodiment, the information processor 100 performs the same processing as that of the flowchart shown in FIG. 8. There are parts of the photographic process (step S805) that are different. An explanation is provided of the photographic process part of the present embodiment, with reference to FIG. 13.

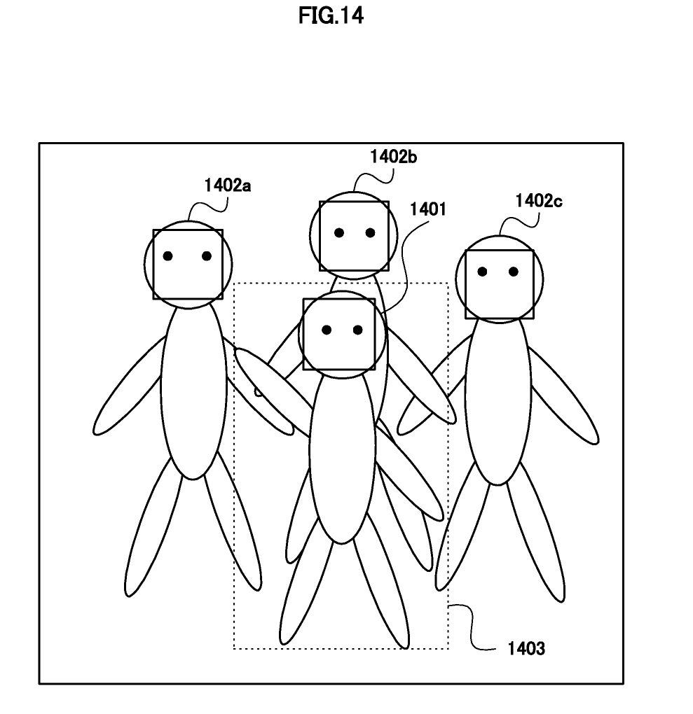

The camera 113, as shown in FIG. 14, photographs the player 1401 and spectators 1402a-1402c. (Step S1301). Also, where the face of an individual is located is recognized (step S1302) by the recognizer 602. By recognizing the face of an individual, the location of each individual can be identified.

When the faces of individual subjects are recognized, a certified code is applied and differentiated relative to the face of each individual subject. In the present embodiment, relative to the recognition of the face of each individual subject, a certified code of individual subject A, individual subject B, individual subject C and individual subject D is applied, differentiating 4 individuals.

Also, concerning differentiated individuals, the movement of the faces photographed at fixed intervals is detected by the detector 603 (step S1303). The detector 603 compares 1st image data photographed immediately prior to the detection time with 2nd image data photographed at the time of detection, and determines whether an individual face has moved. For example, in FIG. 16, in the case of detection time “1100”, comparison is made between the 1st image data photographed immediately prior to the detection time “1100” and the 2nd image data photographed at the time of detection “1100”, and determines whether an individual face has moved. If judged to have moved, then “1” is entered in column 1602 relating to whether or not there has been facial movement and if judged not to have moved, then “0” is entered into the individual subject column 1602 relating to facial movement.

At the same time, the sensor 604 determines whether actions, or in other words operations, of the controller are sensed. If actions are sensed by the sensor 604, then “1” is entered in column 1603 relating to the presence/absence of detection, and if actions are not sensed, “0” is entered in column 1603 relating to the presence/absence of detection.

The determinator 605 determines (step S 1304) whether there is association between the actions of the player sensed by the sensor 604 and the facial movement detected by the detector 603.

In other words, if there is facial movement at detection time “1100” and there is input sensing by the sensor 604, then it is determined that there is coupling (step S1304; YES). Even if there is facial movement, if there is no input sensing by the sensor 604, then no coupling (step S1304; NO) is determined to have occurred, and once again facial movement is detected.

Such action processes are repeated for each individual subject; in other words for individual subject A, individual subject B, individual subject C and individual subject D.

According to FIG. 16, a comparison is made between the results of whether there is the presence/absence of the facial movement of each individual subject A, B, C and D, and the action of a player by the sensor 604, in other words the results of whether there has been a controller operation, and if the results are mutually displayed as being “1”, then coupling is determined to exist.

In other words, in FIG. 16, the individuals shown by oblique lines are determined as the individuals coupled with the action of a player and the movement of an individual subject.

In the case of the present embodiment, as shown in FIG. 16, since the facial movement of individual subject C is detected by the coupled activity to be high, individual subject C is identified (step S1305) as being a player 1401.

Subsequently, the results are determined (step S807) by detecting (step S806) the state of the controller, and if the results exceed the fixed results, there is movement (step S808) to the image processing step.

With the present embodiment, the technique for specifying the player by the determinator 605 is the technique in which the presence/absence of movement of the face of the player is made binary and obtained by detector 603, and the presence/absence of a controller operation is made binary and obtained by sensor 604 however, it is also possible to make accurate determination by continuously detecting changes.

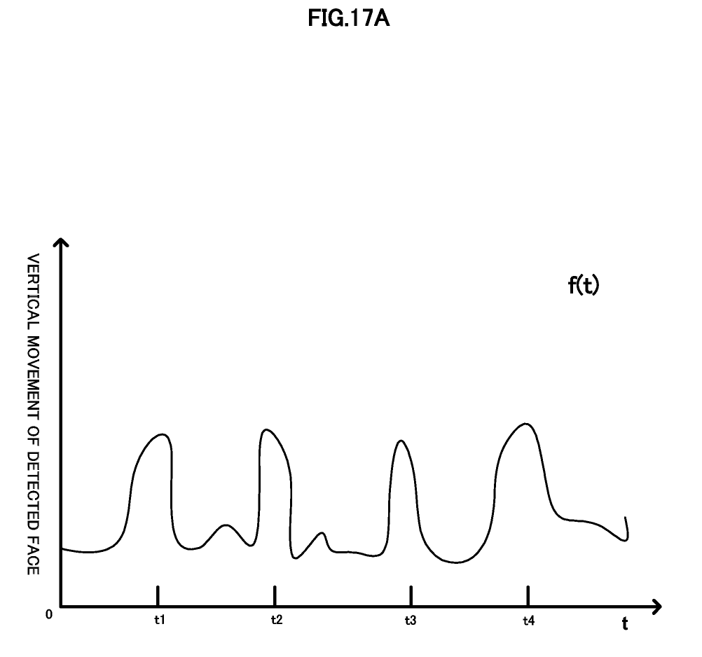

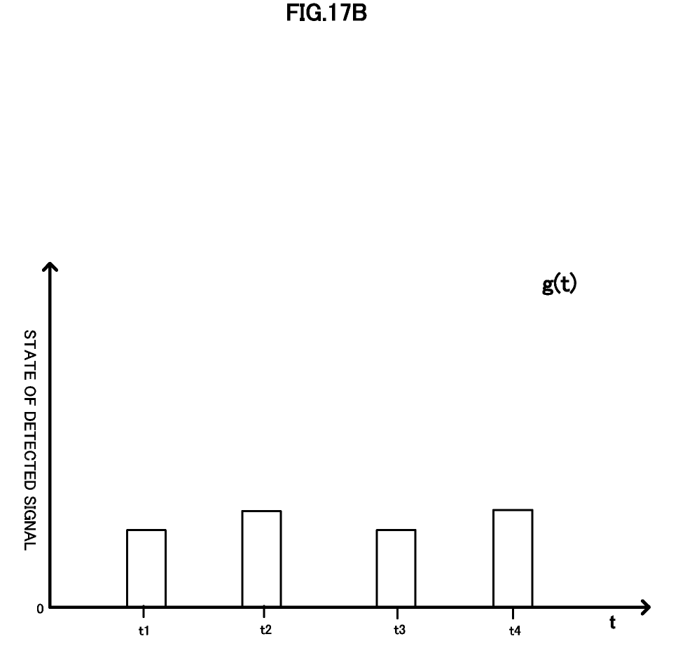

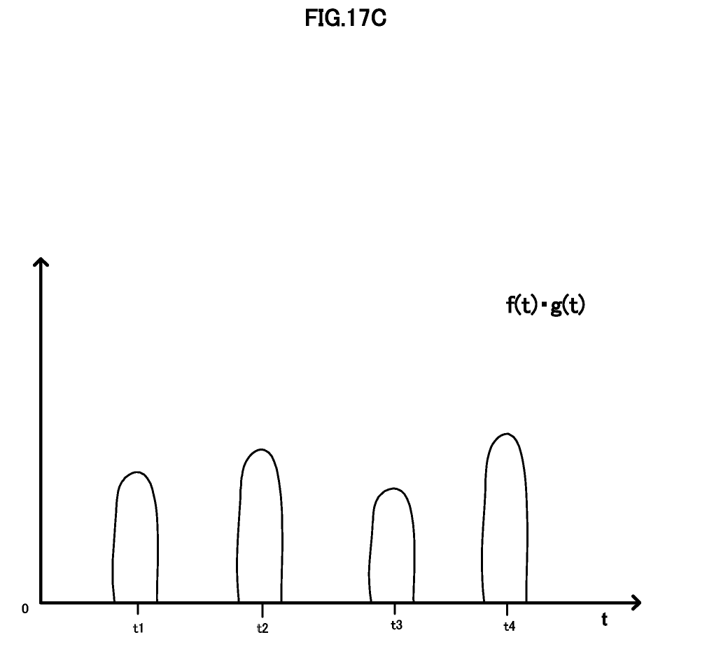

FIG. 17A is a graph showing the running timeline of the vertical movement of the detected face of a specific individual. It is a graph which takes the elapsed time along the horizontal axis, and taking the amount of vertical movement of the face of an identified individual detected by the detector 603, shows the transitional movement of the face of the player. T1 of the horizontal axis corresponds to the subject time 1100; t 2 corresponds to the subject time 1200; t 3 corresponds to the subject time 1700 and t 4 corresponds to the subject time 1900.

FIG. 17B is a graph shown along a timeline wherein, whether a specific individual has pressed a button is sensed by the sensor 604, and the state of the detected signal is subsequently shown. Nos. t 1, t 2, t 3 and t 4 correspond to the same subject time as that shown in FIG. 17A.

As shown in FIG. 17A, regarding the vertical movement of the face, in the portions of the subject times t 1, t 2, t 3 and t 4, vertical movement in the upward direction becomes respectively greater. On the other hand, as shown in FIG. 17B, a step signal is also sensed by the sensor 604 as the signal input by the portions of the subject times t 1, t 2, t 3 and t 4.

In a graph showing such characteristics, with the vertical movement of the face shown in FIG. 17A as the function f(t), the state of the detected value signal shown by FIG. 17B is represented by the function g(t). The correlation of both is manifest by ∫f(t) g(t) dt, and there is correlation to the extent that the value is large.

In addition, if the value shown in FIG. 17A, and the value shown in FIG. 17B are integrated with subject time units, in other words, the value calculated by the formula Σf(Δt·i)(Δt·i) can be shown by FIG. 17C, and to the extent that the integrated value is large, the correlation between both is judged to be large. These processes are accomplished by the determinator 605, and if the correlation is determined to be great, then an individual having such correlation has a high possibility of being identified as a player. In the present embodiment, an individual having the characteristics shown in FIG. 17A-FIG. 17C is identified as a player. Such a process is performed for each individual, and the correlation determined.

In the present embodiment, if the results of player 1401 exceed a fixed valuation, it is determined to be “good”, and the corresponding photographic image moves to the image processing step. In other words, the region which includes the player shown by the dotted line in FIG. 14 is cut out as a display image 1403.

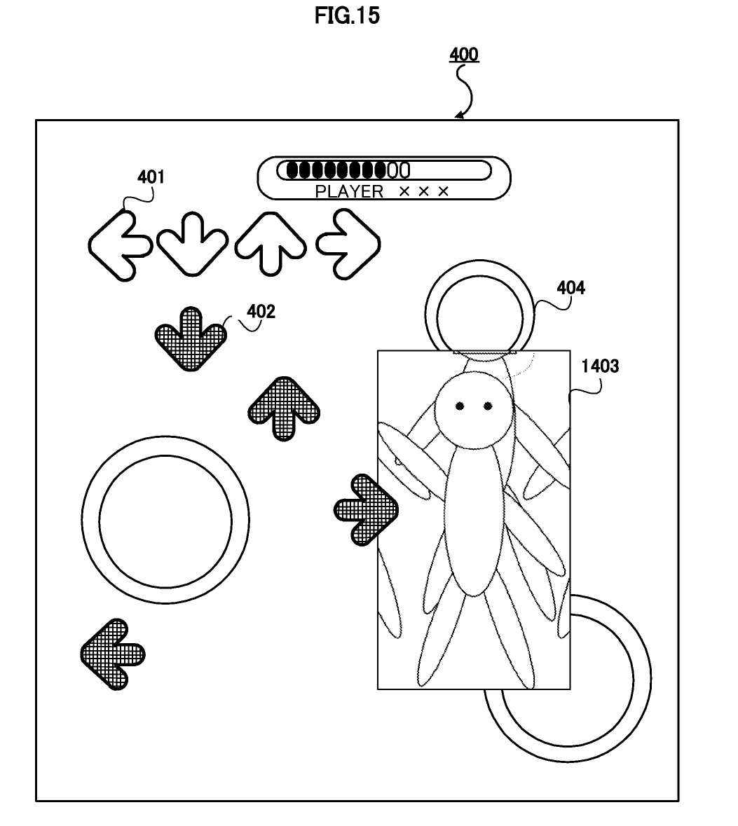

Also, the display image 1403, as shown in FIG. 15, is pasted as an overlay on the background image 404, and displayed on the screen 400.

Furthermore, in the present embodiment as well, the results of valuation not only can be the two stepped “good” or “bad”, but by determining whether the timing of the player activity belongs to any of the divisions of A, B and C within the threshold time d the results can be step valuated, and reflected in the displayed image.

### Fourth Embodiment

In addition, in aforementioned First Embodiment to Third Embodiment, the player is one individual. However, it is also possible for there to be multiple players, in which case multiple players are shown on a screen.

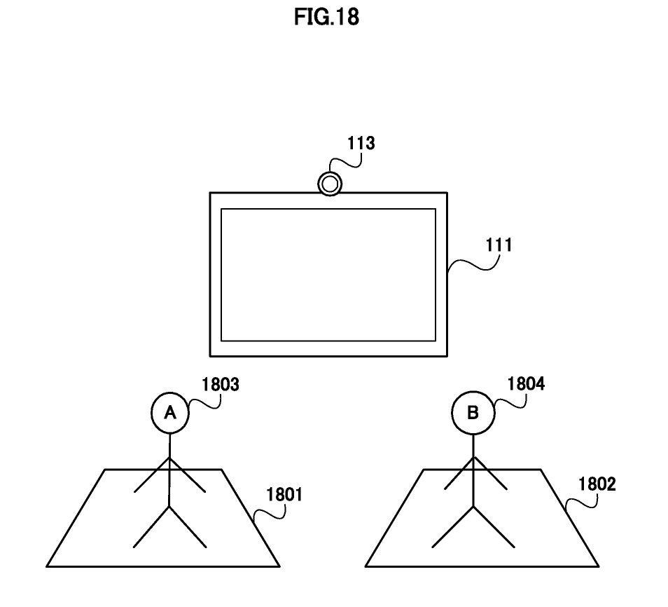

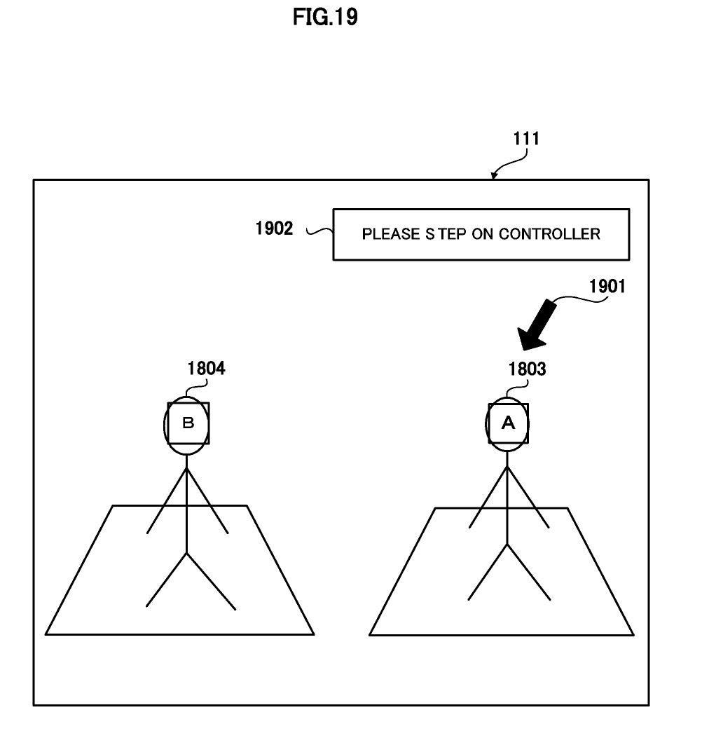

A practical example is explained hereafter, with reference to FIG. 18 and FIG. 19.

As shown in FIG. 18, in the case of two players, a player A (1803) uses a mat-type controller 1801, and a player B (1804) uses a mat-type controller 1802. A sensor (not shown in the diagram) which determines whether the mat has been stepped on, is attached to the respective mat-type controllers 1803 and 1804.

In addition, a monitor 111 is provided with a camera 113, which photographs the player A and the player B.

In a present embodiment as well, as with Second and Third Embodiments, faces are recognized by the recognizer 602, enabling a face to be detected. However, since there are two players, there is a need to establish preconditions in order to differentiate between the detected faces and the players.

Owing to this, as shown in FIG. 19, prior to the commencement of play the two players are photographed, and the respective faces of the recognized images are displayed on the monitor 111. An arrow symbol 1901 is displayed in the vicinity of the photographic image of player A (1803), and at the same time, the instruction “please step on the controller” (1902) is displayed. When the arrow symbol 1901 is displayed along with the indication, the player A steps on any of the buttons of his own mat-type controller. By so doing, the conditions are established for differentiating between the image of a player A and the mat-type controller of a player A.

In the same manner, since the arrow symbol and indications are displayed in the vicinity of the photographic screen of a player B (1804), the player B, by stepping on any of the buttons of his own mat-type controller, establishes conditions for differentiating between the image of the player B and the mat-type controller of the player B.

After completion such a condition establishment process, the game commences.

It is also possible for the game to proceed with the same steps as those in the case of one player. If the type of button pressed by one of the players is coupled to the timing of the press operation of the player, a process takes place to display the image of that player on a monitor. Regarding the other player as well, the same process is individually performed.

On the other hand, it is also possible to perform competition specific game development.

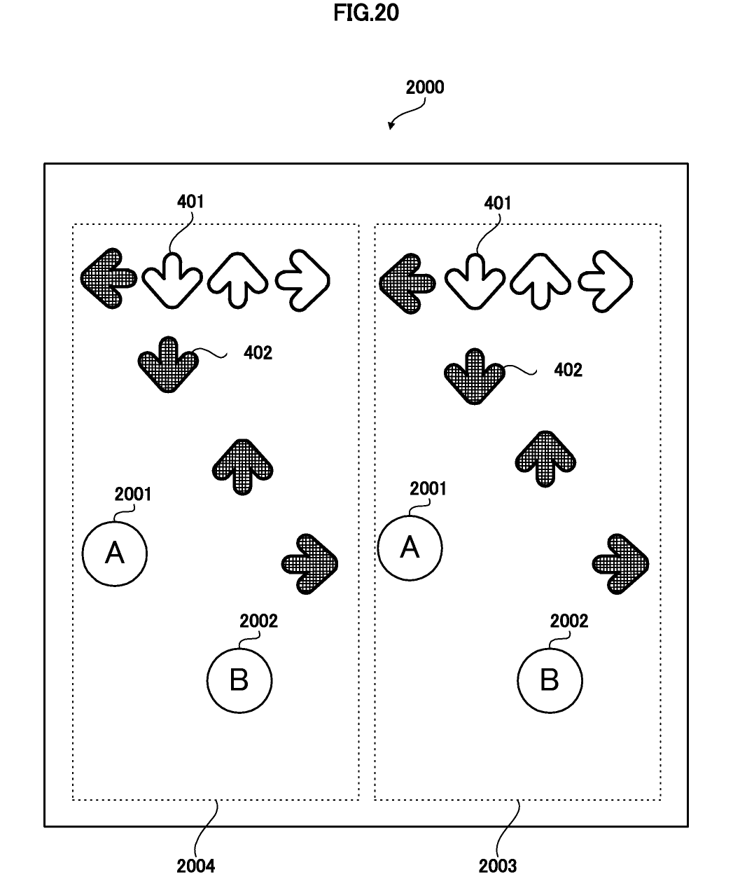

As shown in FIG. 20, by using the actual photographic images of a player A and a player B as the indication images on a game screen, a competitive game can be enjoyed.

In FIG. 20, in the upper part of a game screen 2000, a standard mark 401 is fixedly displayed, facing upward from the lower part of the screen, and the horizontal and vertical step position indication marks 402 are scroll displayed. A part of the scroll displayed step position indication mark 402 is replaced with the photographic image of the players or the photographic image of the players is added and displayed. If desired, the face can be cut out from the photographic image of the players, and displayed, and a facial display (2001) of the player A, and the facial display (2002) of player B can be vertically scroll displayed from the bottom, as step position indication marks.

In the game screen 2000, the display shown by the grid line 2003 is the game screen used by the player A, and the display shown by the grid line 2004 is the game screen used for the player B.

An explanation is provided concerning the state of progression of the game of a game device such as that displayed by the game screen 2000. If the players A and B commence a game, then following the indication images displayed on the respective game screens 2003 and 2004, the respective controllers are operated and the game progresses.

Each player A and B, when the facial display (2001, 2002) of the player A and the player B scroll displayed on the screen 2000 are such that each facial display overlaps with the standard mark 401, press a corresponding button of the controller.

Also, when the results are evaluated by the timing of pressing the controller button, the photographic image of the player responding to the results is displayed on the screen 2000. In a competitive game, the photographic images displayed on the screen change depending upon whether the control button is pressed and at what time relative to the facial display of player A and player B.

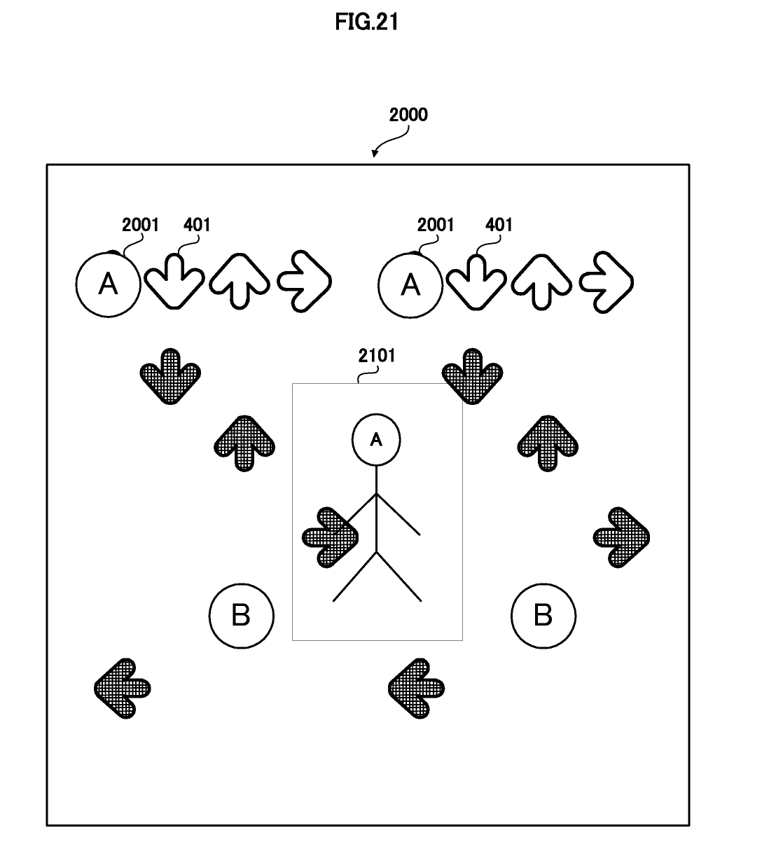

As shown in FIG. 21, with the controller operation of a player A, when the facial display 2001 of the player A overlaps the standard mark 401, the results are determined by the evaluator 606 to exceed a fixed value, and when, in the same manner, the controller operation of a player B is determined by the evaluator 606 to be less than a fixed value, since the evaluation of the player A is higher, then the photographic image of the player A is built up on game screen 2000. In other words, as shown in FIG. 21, image processing is executed to cut out the photographic image of player A, and the image is displayed as display image 2101 on the game screen 2000.

By such a screen display, the player A can establish a sense of self-worth relative to the player B.

In the same scene, if the operation of both the controller of a player A and the controller of a player B relative to the facial display 2001 of the player A is determined by the evaluator 606 to exceed a fixed record, since the controller operation of the player B is also successful, the photographic image of the player A is not displayed on the game screen 2000. Conversely, if the controller operation of the player A is less than a fixed record and the controller operation of the player B exceeds a fixed record relative to the facial display 2001 of the player A, then since the evaluation of the player B is higher, the photographic image of the player A is not displayed on the screen.

At this time, the photographic image of the player B may be displayed on the screen. By making such a display, the player B can demonstrate himself the superiority of the operation of his controller over that of the player A.

In addition, if the facial image 2002 of the player B overlaps the standard 401 mark, the process is the reverse of that displayed above.

Moreover, the facial images of both player A and player B may be displayed during one game, or only one may be displayed. In addition, there may be one display or multiple displays of the facial image of the same player.

According to the present embodiment, through a competitive game, the photographic self-image of the more skillful of the players in the operation of the controller can be made to be displayed on a monitor, or the photographic image of the other player can be suppressed so as not to be displayed on the monitor. A player can demonstrate his own superiority at playing by practicing this type of game method.

Having described and illustrated the principles of this application by reference to one (or more) preferred embodiment(s), it should be apparent that the preferred embodiment(s) may be modified in arrangement and detail without departing from the principles disclosed herein and that it is intended that the application be construed as including all such modifications and variations insofar as they come within the spirit and scope of the subject matter disclosed herein.

As explained above, by displaying the image of the photographed player on a game screen corresponding to the results of play actions, a game device, game process method and program can be offered, which is suitable to achieving player satisfaction.

What is claimed is:

1. A game device comprising:
a display that displays an indication image showing a type of an action to be taken by a player and a timing on a screen;
a sensor that senses the action taken by the player,
an image capturer that photographs the player; and
an evaluator that evaluates results based on whether there is conformance between the type of the action and the timing indicated by the indication image and the type of the action and the timing taken by the player and sensed by the sensor,
wherein when the evaluation by the evaluator is greater than that specified, the display displays an image photographed by the image capturer on the screen, along with that of the indication image.

2. The game device according to claim 1, further comprising:
a recognizer that recognizes a face of an individual based on the image photographed by the image capturer;
a detector that detects a movement of the face of the individual recognized by the recognizer; and
a determinator that determines the individual to be the player when connected to the action of the player sensed by the sensor and to the movement of the face of the individual detected by the detector.

3. The game device according to claim 1, wherein the image photographed by the image capturer is displayed on the screen by the display, after applying an image filter attached corresponding to the evaluation by the evaluator.

4. The game device according to claim 1, wherein the image capturer photographs the image of the player at timing to be taken for the action shown by the indication image displayed on the screen.

5. A game control method comprising:
displaying an indication image that shows a type of an action to be taken by a player and a timing on a screen;
sensing the action taken by the player;
capturing the player; and
evaluating results based on whether there is conformance between the action and the timing indicated by the indication image and the action and the timing taken by the player and sensed by a sensor,
wherein when the evaluation by the evaluation is greater than that specified, the display displays the image photographed by an image capturer on the screen, along with the indication image.

6. A computer-readable non-transitory information recording medium on which a program is recorded for causing a computer comprising a memory capable of storing multiple pieces of information to function as:
a display that displays an indication image showing a type of an action to be taken by a player and a timing on a screen;
a sensor that senses the action taken by the player,
an image capturer that photographs the player; and
an evaluator that evaluates results based on whether there is conformance between the type of the action and the timing indicated by the indication image and the type of the action and the timing taken by the player and sensed by the sensor,
wherein when the evaluation by the evaluator is greater than that specified, the display displays an image photographed by the image capturer on the screen, along with that of the indication image.
